(19) United States
(12) Patent Application Publication
(10) Pub. No.: US 2003/0068160 A1
(43) Pub. Date: Apr. 10, 2003

(54) Digital video / audio broadcast device

(76) Inventor: Ching-Yuan Wei, Chang Hua Hsien (TW)

Correspondence Address: BIRCH STEWART KOLASCH & BIRCH, PO BOX 747, FALLS CHURCH, VA, 22040-0747, US

(21) Appl. No.: 09/972,870

(22) Filed: Oct. 10, 2001

(51) Int. Cl. H04N 5/92; H04N 5/781

(52) U.S. Cl. 386/111; 386/126

(57) ABSTRACT

A digital video/audio broadcast device discloses a video/audio CD-ROM device that is able to directly read and broadcast video/audio data stored in a memory card. The digital video/audio broadcast device includes a memory slot on the video/audio CD-ROM device and a built-in video/audio broadcast program in the video/audio CD-ROM device to broadcast digital images or audio data in a memory card directly through the video/audio broadcast program and an interface operating program supplied by a digital video/audio decompressing card built-in the video/audio CD-ROM when a memory card with video/audio data, such as a compact flash card (CF card), is plugged in the video/audio CD-ROM device.

### BACKGROUND OF THE INVENTION

1. Field of the Invention

The invention relates to a video/audio CD-ROM, and more particularly to a digital video/audio broadcast device with a built-in memory slot and digital video/audio decompressing that can directly read and broadcast digital video/audio data stored in a memory card.

2. Related Art

With the development of digital technology in the information industry, the use of memory cards has become very popular. For example, notebook computers, digital cameras, digital video cameras, personal digital assistants (PDA), and cell phones can all store a large amount of digital data in their memory card.

In this case, the memory card is generally called as a solid state storage carrier. Flash memory is mainly used as the storage carrier. Well-known memory card products are compact flash cards (CF cards), smart media cards (SMS cards), multi media cards (MMC cards), memory stick cards (MS cards), PC cards, and secure digital cards (SD cards). PC cards are also known as PCMCIA cards, meaning Personal Computer Memory Card International Association, and they are a specification of built-in circuit cards for portable computers. Their main objective is improving the expandability of portable computers through PCMCIA slots. Their appearance and size can be divided into three specifications: TYPE I, TYPE II, and TYPE III.

Aside from PC cards, the sizes of other memory cards are all different and are supported by different industries. Digital camera companies such as Kodak, Canon, or Nikon, mainly promote CF cards. However, cell phone companies like Nokia, Ericsson, or Motorola, utilize light, thin, and small MMC cards. SD cards are supported by Japanese video household appliance manufacturers, such as Panasonic and Toshiba. Meanwhile, SMS cards are mostly used by Japanese digital camera and American and Taiwanese MP3 walk-man manufacturers. Nevertheless, they can still connect with a digital product, such as a notebook computer, via a standard PCMCIA slot through a PCMCIA adapter.

CF cards have the advantages of high-capacity (each piece has 192MB) and low-cost. Most digital cameras and digital video cameras use CF cards for recording digital images. No matter whether CF cards or other memory cards are used in digital cameras and digital video cameras, images can be taken as a kind of “digital negative”.

Though CD-ROM drives and memory cards are very popular, present video/audio CD-ROM devices can only broadcast contents recorded on the CD-ROMs, and the content in the memory cards cannot be broadcast. Users must connect digital cameras or digital video cameras that use memory cards with the video/audio CD-ROM devices via connection cables to make the digital cameras reading devices to output digital images to the video/audio CD-ROM devices. Otherwise, through other compatible reading devices, such as computers or mice with reading machines, digital images recorded on the memory cards can be obtained and broadcast.

### SUMMARY OF THE INVENTION

A primary objective of the invention is therefore to provide a digital video/audio broadcast device that can directly read and broadcast digital video/audio data stored in a memory card to solve the above mentioned problems.

Another objective of the invention is to improve the convenience of the video/audio CD-ROM devices. The video/audio CD-ROM device of the invention can not only broadcast CD-ROMs but can also directly broadcast digital video/audio data recorded in the memory cards.

According to the claimed invention, the video/audio CD-ROM device includes memory card slots and built-in video/audio broadcast programs.

In the preferred embodiment of the invention, the memory card slots mainly use PCMCIA standard interfaces, can selectively collocate PCMCIA/CF card adapters, PCMCIA/SMC card adapters, and PCMCIA/MS card adapters to capacitate with other specific memory cards, such as CF cards, SMC cards, and MS cards, and obtain recorded digital video/audio data.

The invention includes a built-in a video/audio program and an interface operating program in a digital video/audio decompressing card of the video/audio CD-ROM device to directly identify the format of digital video/audio data recorded in the memory card. Furthermore, the interface operating program can display operating windows on a monitor (such as a television monitor) for users to process related operations with buttons or a remote control.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow. However, the following description is for purposes of illustration only, and thus is not limitative of the invention, wherein:

FIG. 1 is a structure block diagram of the invention.

FIG. 2 is a detailed structure diagram of another embodiment of the invention.

FIG. 3 is a partial function block diagram of the invention to display the static image decompressing software built-in the digital video/audio decompressing card.

### DETAILED DESCRIPTION OF THE INVENTION

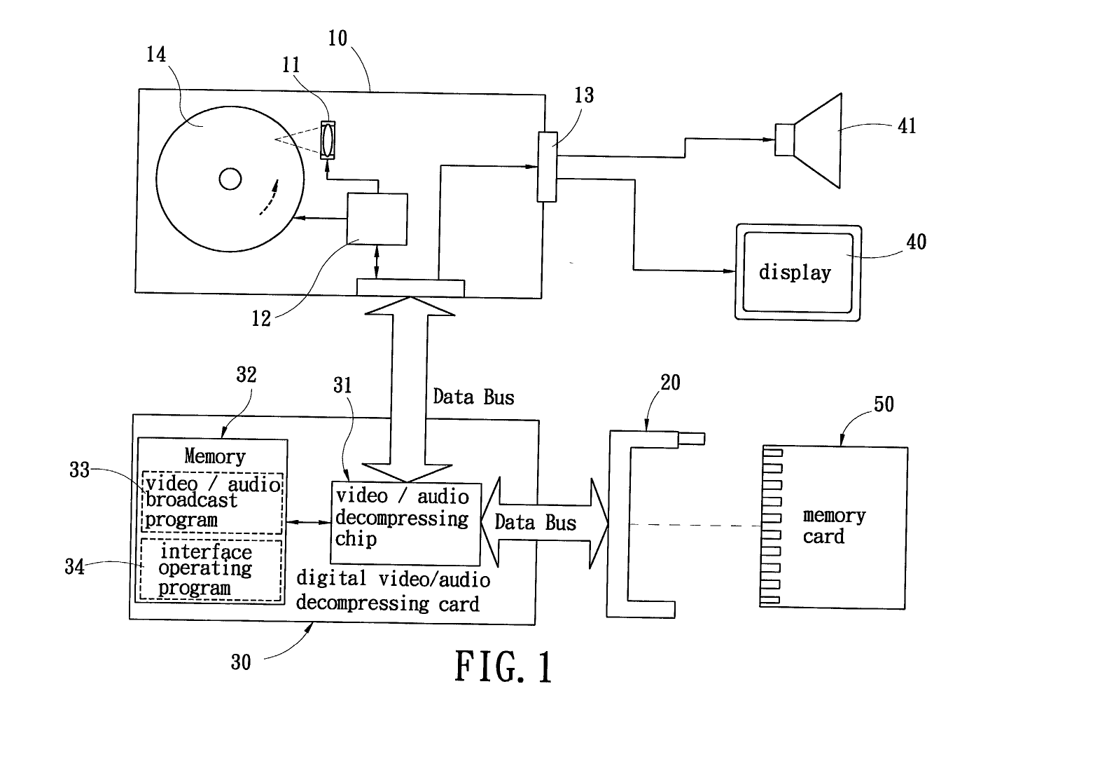

Please refer to FIG. 1. The digital video/audio broadcast device of the invention comprises:

a CD-ROM device 10 comprising a basic CD-ROM reading mechanism, such as an optical pick-up head 11 used to pick up data of a CD-ROM 14, a driving unit 12 used to move the optical pick-up head 11 and rotate the CD-ROM 14 (such as a motor and its relative mechanism), and a video/audio signal output connecting port 13;

a standard PCMCIA slot 20 for installing a memory card 50 with PCMCIA specifications; and

a digital video/audio decompressing card 30 connected to the CD-ROM device 10 and the memory card slot 20 through a data bus, basically composed of a video/audio decompressing chip 31 and memory 32, supporting decompression capability of video/audio data in MPEG II format and audio data in MPEG III format for processing video/audio data from the memory card 50 or the CD-ROM 14 read by the CD-ROM device 10, then outputting to a video/audio output device, such as a display 40 or a speaker 41 through the above mentioned video/audio signal output connecting port 13; the memory 32 includes a built-in video/audio broadcast program 33 and an interface operating program 34; the interface operating program 34 displays operating windows on the display 40 (such as a television monitor) for users to process related operations of video/audio broadcasting with operating buttons or a remote control.

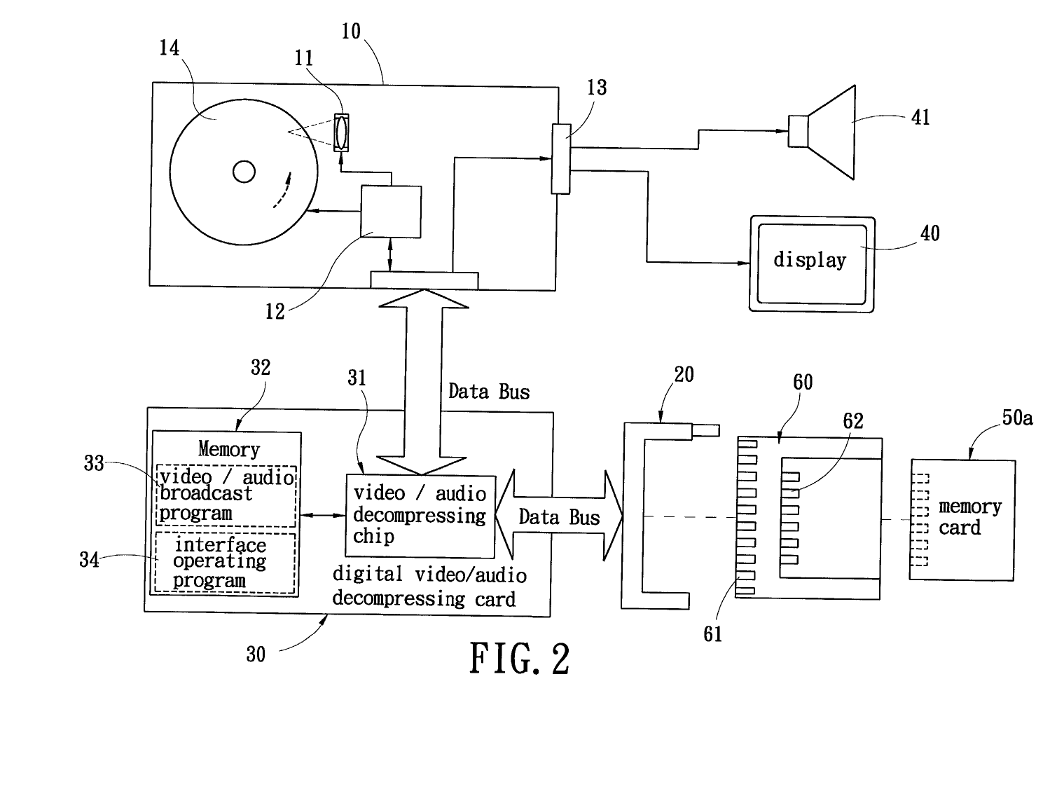

Please refer to FIG. 2. There are many different kinds of memory cards 50. Thus, another embodiment of the invention provides an adapter 60 for connecting memory cards 50a that are not of PCMCIA standard to the standard PCMCIA slot 20. The adapter 60 comprises a plug 61 with PCMCIA specifications and an adapting slot 62 for a memory card. The specifications of the adapting slot 62 of the adapter 60 can be manufactured to suit different kinds of memory cards 50a, like compact flash cards (CF cards), memory stick cards (MS cards), secure digital cards (SD cards), smart media cards (SMC cards), or multi media cards (MMC cards), and connect them to the standard PCMCIA slot 20 through the plug 61 at the other end.

The above-mentioned CD-ROM device 10 can be a read-only CD-ROM device (such as CD-ROM or DVD-ROM), a read/write CD-ROM device (such as CD-R/RW or DVD-R/RW), or a household video/audio CD-ROM device (such as CD/LD/DVD/MP3 player).

Most memory cards 50 store static digital image data in a JPEG file format. Thus, the invention utilizes technology for software identification. The built-in video/audio broadcast program 33 in the memory 32 is used to identify the image file formats in the memory card 50. A microprocessor in the video/audio decompressing chip 31 then decompresses the file and outputs to the display 40 for broadcasting.

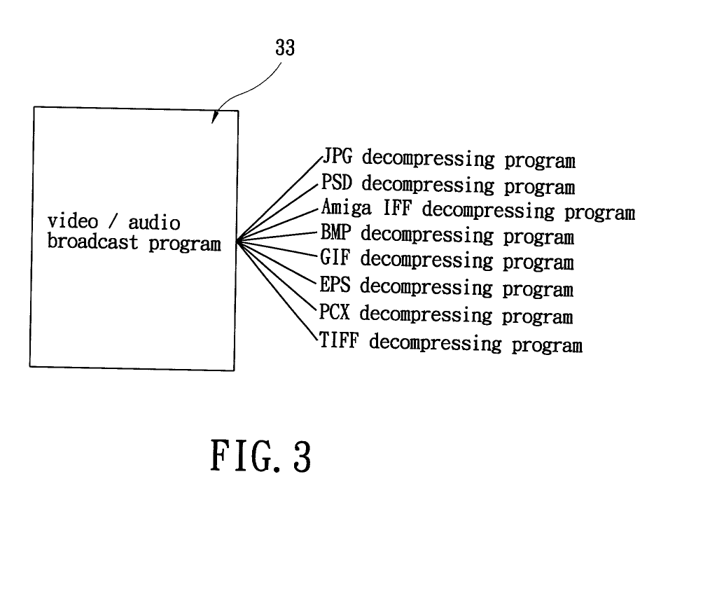

The preferred embodiment can further load software supporting other file formats in the memory 32 (see FIG. 3) to support decompression of static image data with different file formats, such as PSD, Amiga IFF, BMP, GIF, EPS, PCX, and TIFF.

Finally, the interface operating program 34 displays an operating window for users to control the static image with buttons or a remote control. Users can broadcast multiple static images simultaneously, broadcast a single static image, or rotate, mirror, reverse, move, or magnify/reduce the images. Similarly, users can broadcast the digital audio data recorded in the memory card 50 by decompressing via the video/audio decompressing chip 31 and broadcasting via the video/audio broadcasting program 33.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A digital video/audio broadcast device comprising:
a CD-ROM drive comprising an optical pickup Head, a driving unit for moving the optical pickup head and a CD-ROM, and a video/audio signal output connecting port;
a standard PCMCIA slot for installing a memory card with PCMCIA specification; and
a digital video/audio decompressing card connecting with the CD-ROM drive and the memory card slot through a data bus comprising a digital video/audio decompressing chip and a memory, the digital video/audio decompressing chip supporting a decompressing ability of video data with MPEG II format and audio data with MPEG III format for processing video/audio data in the memory card or the CD-ROM and outputting to a video/audio output device through the video/audio signal output connecting port, the memory comprising a video/audio broadcast program and an interface operating program, the interface operating program displaying ways to operate windows on the terminal video/audio output device for users to process video/audio broadcast operations.

2. The digital video/audio broadcast device of claim 1 wherein the CD-ROM device is a DVD video/audio CD-ROM device.

3. The digital video/audio broadcast device of claim 1 wherein the CD-ROM device is a CD video/audio CD-ROM device.

4. The digital video/audio broadcast device of claim 1 wherein the CD-ROM device is an LD video/audio CD-ROM device.

5. The digital video/audio broadcast device of claim 1 wherein the CD-ROM device is an MP3 video/audio CD-ROM device.

6. The digital video/audio broadcast device of claim 1 wherein the CD-ROM device is a read-only CD-ROM device.

7. The digital video/audio broadcast device of claim 1 wherein the CD-ROM device is a read/write CD-ROM device.

8. The digital video/audio broadcast device of claim 1 further comprising an adapter for connecting a memory card with un-PCMCIA standard to a PCMCIA slot.

9. The digital video/audio broadcast device of claim 8 wherein the adapter comprises a plug with PCMCIA standard and a adapting slot connecting with the plug, the plug can plug in the standard PCMCIA slot, and the adapting slot can be plugged by the memory card with un-PCMCIA standard

10. The digital video/audio broadcast device of claim 9 wherein the adapting slot can be plugged by a compact flash card.

11. The digital video/audio broadcast device of claim 9 wherein the adapting slot can be plugged by a memory stick card.

12. The digital video/audio broadcast device of claim 9 wherein the adapting slot can be plugged by a secure digital card.

13. The digital video/audio broadcast device of claim 9 wherein the adapting slot can be plugged by a smart media card.

14. The digital video/audio broadcast device of claim 9 wherein the adapting slot can be plugged by a multi media card.

15. The digital video/audio broadcast device of claim 1 wherein video/audio broadcast program can identify can decompress static image data in JPEG format.

16. The digital video/audio broadcast device of claim 1 wherein video/audio broadcast program can identify can decompress static image data in BMP format.

17. The digital video/audio broadcast device of claim 1 wherein video/audio broadcast program can identify can decompress static image data in GIF format.
